(19) United States
(12) Patent Application Publication
(10) Pub. No.: US 2008/0313239 A1
(43) Pub. Date: Dec. 18, 2008

(54) SURVEY DATABASE METHOD

(76) Inventor: Daniel Byler, Parkersburg, WV (US)

Correspondence Address: BOWLES RICE MCDAVID GRAFF & LOVE LLP, POST OFFICE BOX 1386, CHARLESTON, WV, 25325-1386, US

(21) Appl. No.: 11/762,938

(22) Filed: Jun. 14, 2007

(51) Int. Cl. G06F 17/30

(52) U.S. Cl. 707/201

(57) ABSTRACT

A method for appending each record of a first database with a record from a second database. The records of the first database relate to information pertaining to a specific geographical location, such as an individual residing at a defined residence, or an average or other metric pertaining to all members residing at a defined residence. The second database comprises records containing statistical information pertaining to an overall population within a defined geographical area. The method further provides, for each record of the first database, identifying a record from the second database having a defined geographical area containing the specific geographical location of the record of the first database, and appending the information or fields of the second database record to the first database record.

### BACKGROUND OF THE INVENTION

1. Field of the Invention

The present invention is related to methods for combining database records of different bases.

2. Description of the Prior Art

Surveys are important tools used in commerce, politics and government. Surveys are often used in many commercial decisions, such as determining where to open new retail stores, or targeting specific types of advertisements for specific classes of customers, or deciding what types and variations of products to market in different geographic areas.

Surveys are also used by governments, to determine the size and constituencies of the citizens within a jurisdiction, and to determine the demographic trends within that jurisdiction. The information from these surveys assist government officials in calculating their tax revenue bases and predicting the demand or load on government services, such as schools, road construction, police and fire protection, in the future.

Similar to commerce, surveys are also useful in politics. Political parties always seek to target their advertising and requests for donations to persons who are more likely to be receptive to the platforms and vote for the candidates of a particular political party.

Surveys may be organized to provide a database of discrete information on individual sources or of statistical information on populations. Of the former, a database may contain information on an individual person, such as that person's physical characteristics, e.g., height, weight, race, age; their economic characteristics, e.g., annual income, total assets, total credit card debt; their social characteristics; e.g., religious preference, political party affiliation, social organization memberships; etc. A database of this type may also have information of an individual household, such as household income, number of individuals in a household, whether the household is owned or rented, the value of the household, etc.

Surveys may also be organized to provide a database of statistical information on a population residing within a geographic area. In these databases, the raw data on individuals or households located within a geographic area is processed or analyzed, and presented statistically for that population. This statistical information may include averages, mean, medians or frequency distributions. A frequency distribution is a list or breakdown of the percentage of the population having or exhibiting one of several possible relevant characteristics. For example, one frequency distribution of a population may be the percentages of a population considering themselves of a specific race or religion, or having an income within a specified range.

The information found in surveys organized according to discrete locations or by populations may both be of use to a user in targeting specific households, such as for targeting marketing or political canvassing campaigns. A user may want to only send marketing materials to an individual or household that is registered in a specific political party, which may be determined from county voter registrations, but as well to those living in a household with greater than a specified minimum income. This latter factor may be available only in population survey databases, such as those available from the United States Census Bureau. While a population database would not have the discrete, raw information on an individual or household, it would, through its statistical presentation of the raw data, give a probability of a certain criteria being satisfied with any randomly selected individual or household within the geographic area to which the statistical data applies. For example, statistical data for all households within a certain zip code may show that the gross annual household income is: 25%<$35,000; $35,000<35%<$50,000; $50,000<30%<$100,000 and 10%>$100,000. If a marketer wanted to predominantly target those households having members registered in a specific political party as well as an income over $50,000, he would know that from the statistical data he would have a 40% chance of reaching a desired household in that zip code when selected at random or by using individual, unrelated data. Other zip codes may have different frequency distributions of household income that are more appealing to the marketer.

The principle difficulty in this method of targeted marketing is combining the information from the two formats of databases. Given a specific address from an individual datum in a discretely-based database, one must know the population, and thus the geographic area forming the basis of the population-based database in which the discrete address lies. This would depend on how the geographic area in the population-based database is defined. In some cases, correlating the two databases would be easy and straight-forward, such as where the population is defined as all residents within a zip code and all the discrete addresses are listed with zip codes.

U.S. Census Bureau, the population statistics are formatted over defined geographical areas from which the location of a street address cannot be readily ascertained. Below the county level, the data of the U.S. Census Bureau is statistically organized in geographic areas referred to as blocks, block groups and census tracts.

### SUMMARY OF THE INVENTION

The embodiments of the present invention relate to a method of combining two databases, the first of which is comprised of records related to an individual source, such as an individual person or a household and the second of which is comprised of records having statistical information about a population within a geographic area. This statistical information may be of the same physical, economic or social nature of the information of individual records, but would represent a statistic of that information over a population. Such statistics could include the average or a listing of ranges of responses for the population. The statistics are for a population within a defined geographic area. The defined geographic areas of the population records may be as small as a city block or as large as a zip code or county.

In the embodiments of the present invention, two survey databases are first provided. The first database is comprised of a database of individual information on discrete locations, either of an individual residing at an address, or of a household located at an address. The second database is comprised of statistical information of a population located within the boundaries of some defined geographic area.

The data contained in the two databases are combined by mapping the address of a record in the first database to the geographic area of a record in the second database, and then combining the individual data of the first database record with the statistical information of the corresponding second database record.

### DETAILED DESCRIPTIONS OF PREFERRED EMBODIMENTS

The following discussion describes in detail one or more embodiments of the invention. The discussion should not be construed, however, as limiting the invention to those particular embodiments, and practitioners skilled in the art will recognize numerous other embodiments as well. The complete scope of the invention is defined in the claims appended hereto.

Definitions:

As used herein, the following terms have the following meanings:

a. database: A collection of records containing related information, organized for retrieval.

b. discrete geographic location means a geographic point location, typically a street or mailing address, having or containing a single subject of interest in a survey.

c. geographic area means an area enclosed by a boundary containing a plurality of subjects of interest in a survey.

d. statistical information means information derived from calculations on information on a plurality or populations of subjects of interest. Statistical information may include, but is not limited to, the average, mean or mode values of the information, the deviations from a mean, average or mode values, or histograms of the distribution of values across a population.

e. single subject means the smallest size of a surveyed subject of interest, including an individual person or a household residing at a single address.

In the preferred embodiments of the present invention, a first database is provided, which contains records of information on discrete geographic sources. The sources may be a single individual, or a household of related individuals, such as a family.

Each record of the first database contains relevant information or data for parameters applicable to one single source. Such parameters may include physical information, such an individual's race, age, ethnicity, height, weight, or other physical attributes. It may also include economic information, such as an individual's annual income, overall assets or wealth, or credit card debt. It may also include social information, such as religious preferences, political party affiliations, social and civic organization affiliations.

The data or information in each record of the first database may be determinant or probabilistic. Determinant data is data that is of a specific, identifiable quantity or value for a parameter, such as a household income of $55,000 or an age of 45 years. Probabilistic data could include data expressed as a probable range of values for a parameter, such as household income between $50,000 and $60,000, or as a probability of having a certain value, such as a 35% chance of having a college education.

The first database may also reflect the information concerning all the related individuals residing at the same household, represented by a single, discrete address. For example, a record in a first database may represent the total household income or total debt of all the members of a family.

The records of the first database are unique, meaning that only one record exists for each single source, whether an individual person or a household. There are not multiple records for any one single source. Each record is associated with a fixed point geographical location. This geographical location is typically a street address. Other address formats, including mailing addresses, such as Post Office boxes, are compatible with identifying a geographic location of a single source.

The records may be recorded and stored in various formats, including computerized digital formats or traditional paper records.

In the preferred embodiment of the present method, a second database is also provided. Like the first database, the second database contains information related to the physical, economic or social characteristics of sources of interest. However, in the second database, the information is recorded as statistical information for a population of individuals, households or other single sources within a geographic area of interest. Statistical information could be expressed as, for example, the median income of all individuals or households within a politically defined area, such as a county or state. The statistical information could be expressed in other commonly used statistical terms, such as means, medians, modes or standard deviations. It may also be expressed in terms of histograms, meaning the percentage of the population within a geographic area falling within one of a plurality of bands, ranges, classes or categories. For example, one second database may list the household incomes within a geographic area as: 25% less than $40,000/yr.; 50% greater than $40,000 and less than $80,000/year; and 25% greater than $80,000/year.

In each record of the second database, the records contain statistical information of a population located within a geographic area. Each record of the second database relates to a unique geographic area, preferably without overlap between the areas of any two records. The statistical information in the second database is distinguished from the records of a first database that may have probabilistic data in that the probabilistic data in a first database record would be unique for each source, whether an individual or household, would ordinarily be calculated from other parameters applicable only to that single source, and would vary from other single sources in the neighboring area. On the other hand, the statistical data of a population in the second database applies equally to all single sources within the applicable geographic area.

The geographic area related to the information in a record is identified in the record in a manner which permits placing a geographic point location with respect to the boundaries of the geographic area. This geographic area identification may be sufficient in itself to classify a geographic point, such as the latitude and longitude boundaries of the area. Typically, though, the record will contain an identifier from which the boundaries can be found by referencing another database. For example, a zip code used by the U.S. Postal Service is a well-known identifier of geographic point locations, and the boundaries of each zip code is available from a database available from the Postal Service. The identifier may also be the name of a political division or subdivision, such as the name of a state, county, township, city, etc.

The second database will typically be one of the various census databases available from the U.S. Census Bureau. The Census Bureau conducts comprehensive surveys of all the households in the United States each decade. These surveys include questions on general, physical information, such as the size and composition of households and the race and ages of its members, economic characteristics such as individual and household income; social characteristics, such as education levels, languages spoken and military or veteran status; and housing characteristics, such as the home size, nature of tenancy, and financing.

These responses are tabulated and compiled and available as statistics for geographical areas of varying sizes. The principle geographic division available from the Census Bureau is the Census Tract. A Census Tract is defined with an area as large as a town or a substantial fraction of a town. It is proximate to the size typical of the area covered by a zip code, and usually includes several thousand households. A Census Tract is further subdivided by the Census Bureau into Block Groups and, under that, into Blocks. A block is usually an area containing households bounded by contiguous public roads. A block group contain a number of contiguous blocks, typically the size of a subdivision.

To combine the information in the first and second databases, a street address is identified or extracted from each record, in turn, of the first database, the database records containing information on single subjects, which may include individuals residing at that address, or a household located at that address. The street address associated with each record of the first database is then mapped to a geographic location.

The geographic location to which a street address of the records of the first database is mapped will preferably be the latitude and longitude coordinates. Mapping of a street address to latitude and longitude coordinates is known in the art as geocoding. Geocoding can be done by hand, by a custom-written computer program, or by using websites or geocoding engines available at websites or in commercial software packages.

Geocoding engines or other means of geocoding an address are predominantly based, at least in the United States, on the TIGER® and TIGER/line® databases published by the U.S. Census Bureau. These databases list all the blocks which comprise the various census databases and the address ranges within each block. The TIGER® databases also include a latitude and longitude reference for each block. The TIGER® databases are for sale by the U.S. Census Bureau.

The various geocoding engines available find the latitude and longitude of a street address by taking an address inputted by a user and searching the address ranges of the block records in the TIGER® database until a block is found inclusive of the address of interest. The latitude and longitude of a particular address is estimated by interpolation of the reference latitude and longitude of the block coordinates within the range of addresses in the block.

Once the latitude and longitude of a street address has been estimated or determined, the geographic area of the records in the second database in which the street address would be located can be determined. In the second database, the area included by each record is typically listed by the coordinates of an orthogonal grid. The two orthogonal axes of the grid are each spaced at equal intervals, though the interval spacing of the two axes need not be equal.

Since the origin reference and interval spacing of a grid system is known, the grid block in which a geographic location is located can be easily calculated. The distance between geographic location of interest and the grid system origin is first calculated, and resolved into east-west (longitude) and north-south (latitude) component vectors. The component vectors are divided by the interval widths or heights, respectively, of the grid system, which gives the number of grid intervals from the origin, thereby identifying the grid in which the location is found. The records of the second database are then searched until one or more with the corresponding grid identification is found. The data from this retrieved record is then combined with that of the record of the first database, giving an augmented record of a particular address.

In another embodiment of the invention, the geographic area enclosing a population of a record in the second database can be determined directly through geocoding without having to isolate the latitude and longitude of a street address and determine its distance from a grid origin. The TIGER® database, block records, which include ranges of addresses, also group and classify the blocks into block groups, which in turn are classified and grouped into census tracts. A user may be interested in amending the statistical data available for a census tract into the single subject data of a first database record. In this case, a user merely uses a geocoding technique to identify the census block in which an address is located, and then find the block group, and in turn the census tract to which the block is linked.

Once an amended database is created from the records of the first and second database, having records identifying desirable marketing targets or prospective customers, a targeted mailing list can be created. Alternatively, a map of a neighborhood can be created showing the exact location of prospects, along with the names and other information about those prospects. This would be extremely useful for field canvassers or door-to-door salespeople or solicitors.

While various embodiments of the invention have been described above, it should be understood that they have been presented by way of example, and not of limitation. It will be apparent to persons skilled in the relevant art that various changes in form and detail may be made therein without departing from the spirit, scope or application of the invention. This is especially true in light of technology and terms within the relevant art that may be later developed. Thus, the present invention should not be limited by any of the above-described exemplary embodiments, but should only be defined in accordance with the appended claims and their equivalents.

I claim:

1. A method of appending discrete and statistical survey data, comprising:
a. providing a first database comprising a plurality of records, each record containing information related to a discrete geographic location;
b. providing a second database comprising a plurality of records, each record containing statistical information related to a population within a geographical area;
c. identifying the geographic location of a selected record in the first database;
d. identifying a record in the second database having a related geographic area which encloses the geographic location of the first database selected record;
e. appending the statistical data of the record of the second database to the first database selected record.

2. The method of claim 1, wherein the discrete geographic location is a street address or a private residence.

3. The method of claim 1, wherein the information contained in the records of the first database is selected from the group consisting of household income and individual political registrations.

4. The method of claim 1, wherein the information in the plurality of records in the first database is of a household.

5. The method of claim 1, wherein the information in the plurality of records in the first database is of an individual residing at a household.

6. The method of claim 1, wherein the second database is one published by the United States Census Bureau.

7. The method of claim 6, wherein the related geographic area of the records of the second database is a block.

8. The method of claim 6, wherein the related geographic area of the records of the second database is a block group.

9. The method of claim 6, wherein the related geographical area of the records of the second database is a zip code.

10. The method of claim 6, wherein the related geographical area of the records of the second database is a county.
